(19) United States
(12) Patent Application Publication
(10) Pub. No.: US 2020/0407820 A1
(43) Pub. Date: Dec. 31, 2020

(54) USE OF COPOLYMERS AS BINDERS FOR PELLETIZING METAL CONTAINING ORES

(71) Applicant: BASF SE, Ludwigshafen am Rhein (DE)

(72) Inventors: Bjoern LANGLOTZ, Ludwigshafen (DE); Shane HOFF, Tucson, AZ (US); Adrian Mauricio VILLANUEVA BERINDOAGUE, Ludwigshafen (DE); Alexej MICHAILOVSKI, Ludwigshafen (DE); Frank DIERSCHKE, Ludwigshafen (DE)

(73) Assignee: BASF SE, Ludwigshafen am Rhein (DE)

(21) Appl. No.: 16/486,703

(22) PCT Filed: Feb. 22, 2018
(86) PCT No.: PCT/EP2018/054402

§ 371 Date: Aug. 16, 2019

(30) Foreign Application Priority Data
Feb. 22, 2017 (EP) 17157296.9

(51) Int. Cl. C22B 1/24; C22B 1/244; C08L 43/02; C08L 33/26; C08L 33/10; C08L 33/08; C08L 81/08; C08F 220/56; C08F 220/06; C08F 228/02; C08F 230/02; C08L 29/04; C08F 216/06

(52) U.S. Cl. CPC C22B 1/2406; C22B 1/244; C08L 43/02; C08L 33/26; C08L 33/10; C08L 33/08; C08F 216/06; C08F 220/56; C08F 220/06; C08F 228/02; C08F 230/02; C08L 29/04; C08L 81/08

(57) ABSTRACT

The present invention relates to the use of copolymers as binders for pelletizing metal containing ores such as iron containing ores. The copolymers comprise monomer units derived from at least one monomer C of formula (I).

The present invention relates to the use of copolymers as binders for pelletizing metal containing ores such as iron containing ores.

### BACKGROUND OF INVENTION

A pelletizing process is a compressionless agglomeration of a material in the form of pellets. A variety of different materials may undergo such a process, including chemicals, metal containing ores such as iron ores, animal feed, and the like.

For example, iron ore pellets are spheres of typically 8 to 18 mm which are used as the raw material for blast furnaces. They typically contain at least 60% to 70% iron and various additional materials adjusting the chemical composition and the metallurgical properties of the pellets.

In a direct reduction process, the pellets having a high, uniform mechanical strength and high abrasive strength increase production of sponge iron when using the same amount of fuel. Iron ore pellets may also be less vulnerable to degradation during transportation due to higher abrasion resistance. Moreover, pellets allow for an easier handling.

The process of pelletizing combines mixing of the raw material, forming the pellet and a thermal treatment baking the soft raw pellet to a hard sphere. The raw material is rolled into a ball and then fired in a kiln to sinter the particles into a hard sphere. The configuration of metal containing ore pellets as packed spheres allows air to flow between the pellets while decreasing the resistance to air that flows up through the layers of material during the smelting. In contrast, the configuration of metal containing ore powder (instead of metal containing ore pellets) in a blast furnace is more tightly packed and prevents the air flow, choking the furnace.

The additional materials that may be added for the pelletizing of a metal containing ore, such as an Fe containing ore, may include additives to control the basicity. Examples of additional materials include limestone and/or dolomite, and solid fuel additives such as coal/coke breeze. Furthermore, a binder may be added. In many cases, Bentonite, an absorbent aluminium phyllosilicate, is used as a binder since its use typically provides pellets with the required mechanical properties, e.g. wet strength, dry strength and drop number. Bentonite swells up on contact with water and forms a viscous sticky mass that is used as the active binder. However, the Bentonite is not burned off during the firing process and thus, residual Bentonite or other silicon-based derivatives thereof formed during sintering remain, which is undesirable.

Other binders, such as the organic binder Alcotac® FE13 (BASF SE) comprising a copolymer of acrylamide and acrylic acid, or cellulose-based binders, are also known to be suitable for the metal-containing ore pelletization. The advantage of organic binders is that they are burned off when sintered and thus, the remaining metal pellets are free from residual organic binder. However, the prior art organic binders alone do typically not provide the same desired mechanical properties to the metal containing pellets compared to Bentonite. Thus, compositions comprising Bentonite together with other binders are oftentimes used as binder.

WO2013010629 (A1) describes binder compositions for pelletization of fine mineral particles comprising a) at least one colloid agent which exerts a cohesive force on the mineral particles forming the pellets, and b) at least one synthetic polymer which disperses mineral particles evenly in the pellets.

U.S. Pat. No. 4,684,549 discloses a process in which iron ore pellets are made by addition of binder comprising organic polymer or copolymer of sodium acrylate and acrylamide.

U.S. Pat. No. 4,728,537 discloses organic polymer binders like cationic polymers from diallyl dimethyl ammonium chloride and quaternised dialkylaminoalkyl (methyl) acrylates and quaternised dialkylaminoalkyl (methyl) acrylamides.

U.S. Pat. No. 4,767,449 relates to a process of agglomerating, comprising a two component binder system, a first component being a binding polymer and a second one being clay. The polymer or copolymers is a derivative from monomer units of acrylamide, sodium acrylate, vinyl acetate and poly (ethylene oxide). The polymer can also be a polysaccharide, e.g. carboxymethyl cellulose, guar gum and hydroxyethyl cellulose.

U.S. Pat. No. 5,294,250 discloses a self-fluxing clay free binder composition comprising in admixture of a carrier selected from the group of synthetic or natural magnesium and/or calcium mineral such as calcite, olivine, magnesite and dolomite, and one organic enhancer consisting of a natural polysaccharide of high viscosity, e.g. guar gum.

Overall, there is still a need to reduce the amount of Bentonite in metal-containing ore pellets while at least maintaining desired mechanical properties of the metal containing pellet.

There is also still a need to provide alternative organic binders for the pelletizing of metal containing ores to afford metal containing ore pellets with desirable mechanical properties.

It is thus an object of the present invention to produce metal-containing ore pellets that provide desired mechanical properties by using organic binders.

### SUMMARY

The object was solved by using a copolymer for pelletizing of metal containing ore, wherein the copolymer comprises monomer units derived from at least one monomer C of formula (I)

H₂C═C(R¹)—R²—O(—CH₂—CH₂—O—)ₖ—CH₂—CH₂—R₃ (I),
wherein R¹ is hydrogen or methyl;
R² is absent, —C(═O)—, —CH₂—, —CH₂—CH₂— or —OR⁴, wherein R⁴ is —(CH₂)ₙ—, wherein n is a natural number from 1 to 6; R³ is hydrogen or OH;
and
k is a number from 0 to 300.

Further, the object was solved by a composition for metal containing ore pelletizing comprising
i. a copolymer as used described above, preferably further comprising monomer units derived from at least one anionic monoethylenically unsaturated, hydrophilic monomer A, at least one uncharged, monoethylenically unsaturated hydrophilic monomer B, and at least one monomer C of formula (I); and
ii. a pelletization aid and/or a water soluble treatment polymer, wherein the pelletizing aid is a water soluble material selected from the group consisting of sodium carbonate, sodium bicarbonate, sodium silicate, sodium phosphate, sodium stearate, sodium benzoate, sodium tartrate, sodium oxalate, sodium citrate, sodium acetate, the corresponding ammonium, potassium, calcium and magnesium salts of the preceding sodium salts, urea and calcium oxide, and preferably is sodium carbonate; and wherein the water soluble treatment polymer has molecular weight of from about 1,000 to about 20,000 and is a synthetic polymer formed by polymerization of water soluble ethylenically unsaturated anionic monomer or water soluble ethylenically unsaturated monomer blend containing at least 50% by weight anionic monomer, and preferably is a homopolymer of acrylic acid.

### DETAILED DESCRIPTION

The present invention relates to the use of a copolymer for pelletizing of metal containing ore, wherein the copolymer comprises monomer units derived from at least one monomer C of formula (I)

H₂C═C(R¹)—R²—O(—CH₂—CH₂—O—)ₖ—CH₂—CH₂—R₃ (I),
wherein R¹ is hydrogen or methyl;
R² is absent, —CH₂—, —C(═O)—, —CH₂—CH₂— or —OR⁴, wherein R⁴ is —(CH₂)ₙ—, wherein n is a natural number from 1 to 6; R³ is hydrogen or OH;
and
k is a number from 0 to 300.

Monomer C is a hydrophilic monomer that may interact with other hydrophilic interaction partners. It was surprisingly found that when a copolymer of the invention, comprising monomer units derived from at least one monomer C, is used as binder in pelletizing metal containing ore, the pellets are superior, e.g. more stable as for example shown by an increased drop number, compared to using other state of the art binder polymers for pelletizing metal containing ore.

In a preferred embodiment, R² is absent, —CH₂—, —CH₂—CH₂— or —OR⁴.

In a preferred embodiment, R¹ is hydrogen.

In another preferred embodiment, R³ is —OH.

In another preferred embodiment, R² is —OR⁴. It is also particularly preferred that n is a number from 2 to 5. In a particularly preferred embodiment, n is 4.

In one embodiment, k is a number from 1 to 300.

In another preferred embodiment, k is a number from about 5 to about 150. In a more preferred embodiment, k is a number from about 5 to 50. It is further preferred that k is a number from 11 to 50.

In a particularly preferred embodiment, k is a number from about 5 to about 75.

In another preferred embodiment, monomer C has a mass average molecular weight (M_{w}) from about 500 to about 12000 g/mol. It is preferred that the M_{w} of monomer C is from about 500 to about 6000 g/mol, more preferably from about 500 to about 4000 g/mol and even more preferably from about 500 to about 3000 g/mol. The M_{w} of monomer C may be determined by gel permeation chromatography (GPC). The skilled person will be aware how to determine the molecular weight of a copolymer by GPC.

In yet another preferred embodiment, the monomer C is vinyl oxybutyl polyethylene glycol. The preparation of vinyl oxybutyl polyethylene glycol is for example described in WO 2014/095608 A2, page 32, Example M1. The vinyl oxybutyl polyethylene glycol may thus be obtained from reacting hydroxybutyl vinyl ether with ethylene oxide.

In a preferred embodiment, the vinyl oxybutyl polyethylene glycol is obtained by using a molar ratio of ethylene oxide to hydroxybutyl vinyl ether of 10:1 to 70:1 for the reaction.

In another preferred embodiment, the vinyl oxybutyl polyethylene glycol is obtained by using a molar ratio of ethylene oxide to hydroxybutyl vinyl ether of 10:1 to 50:1 for the reaction.

In another preferred embodiment, the vinyl oxybutyl polyethylene glycol is obtained by using a molar ratio of ethylene oxide to hydroxybutyl vinyl ether of 15:1 to 35:1 for the reaction.

In yet another preferred embodiment, the vinyl oxybutyl polyethylene glycol is obtained by using a molar ratio of ethylene oxide to hydroxybutyl vinyl ether of 22:1 to 23:1 for the reaction. Such a preferred monomer C is hereafter referred to as “VOBPEG 1100”.

For VOBPEG 500, the molar ratio of ethylene oxide to hydroxybutyl vinyl ether is about 11:1 for the reaction. For VOBPEG 3000, the molar ratio of ethylene oxide to hydroxybutyl vinyl ether is about 68:1 for the reaction. For VOBPEG 5800, the molar ratio of ethylene oxide to hydroxybutyl vinyl ether is about 130:1 to about 134:1 for the reaction.

In one embodiment, monomer C is selected from VOBPEG 500, VOBPEG 1100 and VOBPEG 3000.

In a preferred embodiment, monomer C is VOBPEG 500 or VOBPEG 3000.

In a preferred embodiment, monomer C is vinyl oxybutyl polyethylene glycol with a molecular weight, preferably an average molecular weight (M_{w}), from about 100 to 10000 g/mol, preferably from about 250 to about 4000 g/mol, more preferably from about 500 to 2000 g/mol. An M_{w} of 1100 g/mol or less is particularly preferred.

In a preferred embodiment, the copolymer comprises from 0.1 to 15% by wt. and preferably from 0.5 to 4% by wt. of the at least one monomer C. It is particularly preferred that the copolymer comprises from about 0.5% by wt. to about 3% by wt. monomer C and more preferably from about 2% by wt. to about 3% by wt. monomer C. The % by wt. are based on the total weight of the monomers of the copolymer for pelletizing of metal containing ore.

In the ideal case, the copolymers used in accordance with the invention should be miscible with water in any ratio. According to the invention, however, it is sufficient when the copolymers are water-soluble at least at the desired use concentration and at the desired pH. In general, the solubility of the copolymer in water at room temperature under the use conditions should be at least about 10 g/l or at least 25 g/l.

In a preferred embodiment, the molecular weight of the copolymer is at least 300,000 Da, preferably at least 500,000 Da and even more preferably at least 1,000,000 Da. The person skilled in the art will be aware how to determine the molecular weight of a copolymer, which is typically determined as an average, preferably as the mass average molecular weight (M_{w}) or as a number-average molecular weight (Mₙ). The molecular weight of the copolymer may be determined for example by permeation chromatography which is particularly suitable for the determination of the molecular weight for copolymers having a molecular weight up to about 1 MDa.

In a preferred embodiment, the amount of copolymer used in the intimate mixture for pelletizing of the metal containing ore is generally from about 0.005% wt. to about 0.1% wt., and preferably from about 0.01% wt to about 0.1% wt, based on the weight of the intimate mixture comprising ore, copolymer and moisture. The amount of moisture will vary according to the ore and the process but is typically in the range of from about 7 to about 15%, or from about 8 to about 12% by weight based on the weight of the intimate mixture. Some or all of this moisture may be introduced with the binder copolymer and/or an optional treatment polymer or by a deliberate addition of water, but often all the moisture is present in the ore and all the additives, such as the copolymer, are added dry.

In a preferred embodiment, the copolymer for pelletizing metal containing ores are used in combination with an additional binder. It is particularly preferred that the additional binder comprises an absorbent aluminum phyllosilicate.

In yet another preferred embodiment, the copolymer for pelletizing metal containing ores are used in combination with bentonite. Without being bound by theory, it is assumed that the use of the copolymer according to the present invention in combination with an absorbent aluminum phyllosilicate, preferably bentonite, may be particularly advantageous since the polyethylene glycol (PEG)-chains may modify or interact with the absorbent aluminum phyllosilicate, preferably bentonite, and thereby improve its ability to function as a binder for pelletizing of metal containing ore. The PEG-chains may also directly interact with the iron ore and function as binder.

In another preferred embodiment, the copolymer according to the present invention is mixed with the absorbent aluminum phyllosilicate, preferably bentonite, in a weight ratio from 10 to 50 parts of absorbent aluminum phyllosilicate, preferably bentonite, to 1 part of copolymer.

In another preferred embodiment, the copolymer according to the present invention is mixed with the absorbent aluminum phyllosilicate, preferably bentonite, in a weight ratio from 10 to 30 parts of absorbent aluminum phyllosilicate, preferably bentonite, to 1 part of copolymer.

In another preferred embodiment, the copolymer used according to the present invention further comprises monomer units derived from at least one anionic monoethylenically unsaturated, hydrophilic monomer A. In a preferred embodiment, the at least one monomer A comprises at least one group selected from the group consisting of —COOH, —SO₃H, —PO₃H₂, salts thereof and mixtures of any of the foregoing.

Examples of monomer A comprising —COOH groups include, but are not limited to, acrylic acid, methacrylic acid, crotonic acid, itaconic acid, maleic acid or fumaric acid. In one embodiment, the monomer A comprising —COOH groups comprises crotonic acid, itaconic acid maleic acid or fumaric acid.

Examples of monomers A comprising sulfonic acid groups include vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid or 2-acrylamido-2,4,4-trimethylpentanesulfonic acid. Preference is given to vinylsulfonic acid, allylsulfonic acid or 2-acrylamido-2-methylpropanesulfonic acid.

In a preferred embodiment, the at least one monomer A is 2-acrylamido-2-methyl-propane sulfonic acid (AMPS or ATBS).

Examples of monomers A comprising phosphonic acid groups comprise vinylphosphonic acid, allylphosphonic acid, N-acrylamidoalkylphosphonic acids, N-methacrylamidoalkylphosphonic acids acryloyloxyalkylphosphonic acids, methacryloyloxyalkylphosphonic acids, preference being given to vinylphosphonic acid.

In one preferred embodiment, the copolymer used according to the present invention comprises monomer units derived from at least one monomer C and at least one anionic monoethylenically unsaturated, hydrophilic monomer A.

In another preferred embodiment, the copolymer used according to the present invention further comprises monomer units derived from at least one uncharged, monoethylenically unsaturated hydrophilic monomer B. It is even more preferred that the copolymer comprises monomer units derived from at least one monomer C and at least one uncharged, monoethylenically unsaturated hydrophilic monomer B.

In a preferred embodiment, the monoethylenically unsaturated, hydrophilic monomer B is selected from the group consisting of acrylamide, methacrylamide, N-methyl acrylamide, N-methyl methacrylamide, N,N′-dimethyl acrylamide, N,N′-dimethyl methacrylamide, N-methylol-acrylamide N-methylol methacrylamide, uncharged vinylamides such as vinylformamide or N-vinylpyrrolidone; and mixtures thereof. Preference is given to acrylamide or methacrylamide, especially acrylamide. In a preferred embodiment, when mixtures of different monomers B are used, at least 50 mol % of the monomers B should be acrylamide or methacrylamide, and preferably acrylamide.

In another preferred embodiment, the copolymer according to the present invention does not comprise a COOH or COO⁻ residue as a side chain, and thus, the copolymer according to the present invention is not derived from monomers such as acrylic acid and/or methacrylic acid.

In yet another preferred embodiment, the copolymer according to the present invention does not comprise a hydrophobic radical as a side chain, such as a hydrocarbyl radical containing two or more carbon atoms, including cyclic and aromatic hydrocarbon groups. Acrylic acid alkyl esters also fall within the scope of a hydrophobic radical as side chain.

In yet another preferred embodiment, the copolymer according to the present invention does not comprise an acrylic acid alkyl ester.

In one embodiment, the copolymer according to the present invention does not comprise at least one anionic monoethylenically unsaturated, hydrophilic monomer A and/or at least one uncharged, monoethylenically unsaturated hydrophilic monomer B. In this context, it is to be understood that the presence of monomer C does not automatically mean that a monomer A and/or a monomer B need to be present in the copolymer of the present invention.

In a preferred embodiment, the copolymer comprises monomer units derived from
i. at least one anionic monoethylenically unsaturated, hydrophilic monomer A,
ii. at least one uncharged, monoethylenically unsaturated hydrophilic monomer B, and
iii. at least one monomer C.

The monomers may of course also be the salts of the anionic acidic monomers. Suitable counterions comprise especially alkali metal ions such as Li⁺, Na⁺ or K⁺, and ammonium ions such as NH₄⁺ or ammonium ions with organic radicals.

It is preferred that in a copolymer comprising monomer units derived from Monomers A and B, Monomer A and B are miscible with water in any ratio, but it is sufficient for execution of the invention that the inventive copolymer possesses the water solubility mentioned at the outset. In a preferred embodiment, the solubility of the monomers A and B in water at room temperature should be at least 50 g/l, preferably at least 150 g/l and more preferably at least 250 g/l.

In a preferred embodiment, monomer A is AMPS and/or monomer B is acrylamide.

In yet another preferred embodiment, the copolymer comprises about 2% by wt. at least one monomer C, about 48% by wt. at least one monomer A and about 50% by wt. at least one monomer B, wherein monomer A is preferably AMPS and/or monomer B is preferably acrylamide. The % by weight is in each case based on the total weight of monomers in the copolymer.

In one embodiment, the copolymer used according to the present invention has been made by polymerization of the monomer blend in the presence of at least one branching agent. The branching agent may cause covalent or ionic cross linking through pendant groups, (e.g., by use of a glycidyl ether or multivalent metal salt) but preferably the branching agent is a diethylenically unsaturated monomeric branching agent. The amount of branching agent is preferably in the range of from about 2 to about 200 ppm and more preferably from about 10 to about 100 ppm. The ppm values are based on the total weight of the copolymer.

In a preferred embodiment, the at least one branching agent is selected from methylene bis acrylamide (MBA) and tetra allyl ammonium chloride (TAAC) or combinations thereof.

In a preferred embodiment of the present invention, the copolymer is used for pelletizing of metal containing ore wherein the metal containing ore is selected from the group of Fe containing ore, Cu containing ore, Mo containing ore, Ni containing ore, Cr containing ore or mixtures thereof and preferably is Fe containing ore. In a particularly preferred embodiment, the Fe containing ore comprises magnetite, hematite or goethite or combinations thereof.

The present invention also relates to compositions comprising a copolymer as described above and a pelletization aid and/or a water soluble treatment polymer.

In a preferred embodiment, the inventive composition further comprises at least one metal containing ore as described above. Thus, the composition according to the present invention may be a metal containing ore pelletization composition for pelletization.

In a preferred embodiment, the pelletizing aid is a water soluble material selected from the group consisting of sodium carbonate, sodium bicarbonate, sodium silicate, sodium phosphate, sodium stearate, sodium benzoate, sodium tartrate, sodium oxalate, sodium citrate, sodium acetate, the corresponding ammonium, potassium, calcium and magnesium salts of the preceding sodium salts, urea and calcium oxide.

In a more preferred embodiment, the pelletizing aid comprises sodium carbonate.

In another preferred embodiment, the weight ratio of copolymer to pelletizing aid is generally in the range of from about 5:1 to about 1:5 and more preferably from about 2:1 to about 1:2, by weight.

The ratio of copolymer to treatment polymer is generally in the range of from about 10:1 to about 1:2 and preferably from about 5:1 to about 1:1, by weight.

In another preferred embodiment, the water soluble treatment polymer has a molecular weight (M_{w}) of about 1,000 to about 20,000. It is further preferred that the treatment polymer is a synthetic polymer formed by polymerization of water soluble ethylenically unsaturated anionic monomer or water soluble ethylenically unsaturated monomer blend containing at least 50% by weight anionic monomer.

The treatment polymer is generally formed of from about 50 to about 100% by weight, preferably from about 75 to 100% by weight and even more preferably from about 80 to 100% by weight anionic monomer with the balance being non-ionic monomer which will form a water soluble blend with the anionic monomer. The non-ionic monomer can be a water soluble monomer such as acrylamide or it can be a potentially water insoluble monomer such as an alkyl acrylate or methacrylate, for instance methyl or butyl acrylate, provided that this insoluble monomer can be dissolved in an aqueous solution of the anionic monomer during polymerization and that the blend provides a water soluble polymer.

The anionic monomer is generally ethylenically unsaturated carboxylic monomer, usually in the form of an alkali metal (especially sodium) or other water soluble salt, but if desired some or all of the anionic monomer can be an ethylenically unsaturated sulphonic monomer such as AMPS or allyl sulphonate or vinyl sulphonate. The preferred carboxylic monomers are acrylic or methacrylic acid and most preferably the anionic monomer is sodium acrylate. The preferred treatment polymers are homopolymers of acrylic acid (usually as sodium polyacrylate).

The molecular weight of the treatment polymer is preferably at least 2,000 or 3,000. Often it is below 10,000 and preferably below 8,000, with values of around 3,000 to 6,000 often being preferred, wherein the molecular weight is preferably the weight average molecular weight (M_{w}). The molecular weight may be measured by gel permeation chromatography, preferably measured by size exclusion chromatography using Toao Haes TSK PWXL (G6000+G3000+guard) columns or other suitable columns, e.g. using dipotassium hydrogen orthophosphate trihydrate as eluant, and several sodium polyacrylate standards in the range 782200-1250 g/mol and sodium acrylate monomers as an additional standard. Molecular weights may be measured as the full sodium salt.

Preferred treatment polymers also have narrow molecular weight distributions in addition to the defined very low molecular weight.

Higher molecular weights within the range of 1,000 to 20,000 are sometimes more suitable for the treatment polymers when, as is sometimes preferred, the treatment polymer is to be introduced in bead form. When the treatment polymer is to be supplied in liquid form, the treatment polymer is usually made by solution polymerization in conventional manner. When the treatment polymer is supplied in powder form, the polymer is usually made by reverse phase bead polymerization or by spray drying a solution of the polymer.

If the treatment polymer is in particulate form, it generally has a particle size at least 90% by weight below 300 μm and most preferably below 200 μm and often below 100 μm. Usually the particle size is at least 90% by weight above 10 μm. For example, the particle size may be determined by sieving or laser granulometry.

It will be appreciated that the water soluble treatment polymers used in the invention are materials which are known in the industry as dispersing agents. It may be possible to obtain improved dry strength by the incorporation of the treatment polymer in the inventive composition. Further, this may preferably be achieved when the total amount of binding system (copolymer, treatment polymer and/or pelletization aid) remains constant in the inventive composition.

The amount of treatment polymer which has to be added to the inventive composition will vary according to the nature of the ore and the remainder of the binder system but is often at least 0.005% by wt. and most preferably is at least 0.008% by wt. Often it is in the range from about 0.01 to about 0.05% by wt. Amounts above 0.1% by wt. are usually unnecessary but can be used if desired. The % by wt. are based on the intimate mixture composition comprising metal containing ore, copolymer and moisture.

The treatment polymer may be incorporated in the intimate mixture of ore, binder polymer and moisture by addition at any suitable stage. It is often desirable to mix the treatment polymer intimately with the ore and some or all of the moisture before adding the binder polymer or other components of the binder system. For instance the treatment polymer can be added as a liquid or powder prior to the filters which conventionally precede the addition to binder prior to pelletization in a drum or disc.

In one embodiment, the treatment polymer and copolymer are generally added separately, that is to say from separate supplies, either simultaneously or sequentially in either order. This facilitates the possibility of adding the treatment and copolymers in different physical forms, for instance the treatment polymer as a solution and the binder polymer as a powder. In particular the treatment polymer may be added as a solution before filters and the copolymer as a powder after the filters but before pelletization.

Although it is often convenient to add the treatment polymer as a solution, it is usually preferred to add it as a powder. The powder particles may be added separately from the copolymer (often at the same time as the binder polymer) but often the treatment polymer particles may be added as a blend with copolymer particles.

Instead of adding the treatment polymer as a solution or a blend of particles with particles of copolymer, some of the treatment polymer can serve also as an aggregate bonding agent for aggregates of polymer binder particles, as in EP 376,713. However it is necessary that those aggregates should be disintegratable, as described in EP 376,713, and it is not usually practicable to make disintegratable aggregates containing both the copolymer and all the desired treatment polymer. Accordingly if the copolymer is to be introduced in the form of aggregates it is usually preferred that these do not include treatment polymer as a bonding agent and usually it is preferred that they do not contain any treatment polymer or, if they do, the amount of treatment polymer in the aggregates should be not more than 50%, and generally not more than 10%, by weight of the total amount of treatment polymer used in the invention.

If desired, the composition according to the present invention may further comprise an absorbent aluminum phyllosilicate, preferably bentonite, as an additional binder.

In another preferred embodiment, the copolymer according to the present invention is mixed with the absorbent aluminum phyllosilicate, preferably bentonite, in a weight ratio from 10 to 50 parts of absorbent aluminum phyllosilicate, preferably bentonite, to 1 part of copolymer.

In another preferred embodiment, the copolymer according to the present invention is mixed with the absorbent aluminum phyllosilicate, preferably bentonite, in a weight ratio from 10 to 30 parts of absorbent aluminum phyllosilicate, preferably bentonite, to 1 part of copolymer.

In one embodiment, the inventive composition comprises from about 0 to about 60% by wt. pelletization aid, from about 0 to about 50% by wt. treatment polymer and at least 30% by weight of copolymer, wherein the total wt % of the composition adds up to 100%. In a preferred embodiment, the pelletization aid is sodium carbonate and/or the treatment polymer is polyacrylate.

In the scope of the present invention, “hydrophilic” means that a corresponding solid “hydrophilic particle” has a contact angle of water against air of <90°.

Methods to determine the contact angle are well known to the skilled artisan. For example, for the determination of the contact angle against water may be determined by optical drop shape analysis, e.g. using a DSA 100 contact angle measuring device of Kruss (Hamburg, Germany) with the respective software. Typically 5 to 10 independent measurements are performed in order to determine a reliable average contact angle.

As used herein, the term “ore” or “metal containing ore” refers to a naturally occurring substance that is solid inorganic and representable by a chemical formula, which is usually abiogenic and may have an ordered atomic structure. Examples of metal-containing ores include, but are not limited to, sulfides, oxides, halides, carbonates, sulfates, and phosphates of valuable metals such as Ag, Au, Pt, Pd, Rh, Ru, Ir, Os, Cu, Mo, Ni, Cr, Mn, Zn, Pb, Te, Sn, Hg, Re, V, Fe or mixtures thereof. Preferred metal containing ores are Fe containing ores. Examples of Fe containing ores include, but are not limited to, magnetite, hematite and goethite.

As used herein, the term “monoethylenically unsaturated” as in “monoethylenically unsaturated monomer” refers to an organic compound that contains a —C═C— bond. Preferably, the monoethylenically unsaturated compound contains exactly one —C═C— bond. In the context of a “monoethylenically unsaturated monomer”, it is meant that the monomer preferably contains a functional —C═C— group for polymerization.

As used herein, the term “diethylenically unsaturated” as in a “diethylenically unsaturated monomeric branching agent” means that a compounds contains two —C═C— bonds which are preferably functional groups for polymerization, respectively.

As used herein, the term “anionic” as in “anionic monomer” refers to a negatively charged compound, such as an anionic monomer. However, the term “anionic monomer” as used herein also includes to respective salt comprising the negatively charged anionic monomer and the respective free acid of the anionic monomer, i.e. the negatively charged anionic monomer bound to hydrogen. Examples of anionic monomers thus include monomers containing at least one group selected from —COOH, —SO₃H, —PO₃H₂, or —COO⁻, —SO₃⁻, —PO₃H⁻ or salts thereof. Other examples of anionic monomers include, but are not limited to, vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid or 2-acrylamido-2,4,4-trimethylpentanesulfonic acid, and salts thereof.

As used herein, the term “uncharged” as in “uncharged monomer”, refers to a compound that does typically not dissociate into anions and cations in significant amounts under standard conditions such as in water at room temperature. In the context of uncharged monomers, this means that the monomers may comprise respective functional groups such as amide groups. Thus, examples of uncharged monomers include, but are not limited to, acrylamide, methacrylamide, N-methyl methacrylamide, N-methyl acrylamide, N,N′-dimethyl acrylamide, N,N′-dimethyl methacrylamide, N-methylol acrylamide, N-methylolmethacrylamide or mixtures thereof. It is emphasized that free acids, e.g a compound containing a COOH, —SO₃H or —PO₃H₂ group is not considered as uncharged according to the present invention but as anionic.

As used herein, the term “synthetic polymer” refers to a polymer that had been chemically synthesized, i.e. a human-made polymer. Typically the term synthetic polymer includes thermoplastics, thermosets, elastomers and synthetic fibers. The back bones of common synthetic polymers such as polythene and polystyrene, poly acrylates are made up of carbon-carbon bonds, whereas hetero chain polymers such as polyamides, polyesters, polyurethanes polysulfides and polycarbonates have other elements (e.g. oxygen, sulfur, nitrogen) inserted along the backbone. Also silicon form similar materials without the need of carbon atoms, such as silicones through siloxane linkages; these compounds are thus said to be inorganic polymers. Coordination polymers may contain a range of metals in the backbone, with non-covalent bonding present. The opposite of a synthetic polymer is a naturally occurring polymer such as cellulose.

As used herein, the term “water soluble polymer” refers to polymers having polar or charged functional groups, rendering them soluble in water.

As used herein, the term “Drop number” means the number of the repeated drop of 9-16 mm wet pellets onto a steel plate from a height of 45 cm without any cracks on the wet pellets. The drop number measures the ability of the wet pellets to retain their shape during transfer operations.

As used herein, the term “wet strength” is a measure of how much load a wet pellet can bear and it is determined by applying pressure onto a wet pellet until it cracks and the maximum load is recorded.

As used herein, the term “dry strength” is a measure of how much load a dry pellet can bear. Typically wet pellets may be dried, e.g. for 3 hours at 110° C., and the dried pellet is crushed and the maximum load is recorded. The dry strength may be considered as a measure of the ability of dried pellets to survive handling during the firing process.

Further examples of aliphatic branched carbon radicals include cyclic hydrocarbons such as mono-, bi- or tricyclic saturated or unsaturated hydrocarbons having from 6 to 30 carbon atoms. Examples include, but are not limited to cyclohexyl, cecloheptyl, cyclooctyl, cyclononyl, cyclodecyl, cycloundecyl and cyclododecyl.

Examples of aromatic carbon radicals include, but are not limited to aromatic carbocyclic rings of 6 to 30 ring members, including both mono, bi-, and tri-cyclic ring systems. Non-limiting examples include -indenyl, -phenyl, -naphthyl-, acenaphthyl-antranyl, -phenanthryl and the like.

As used herein, the term “pelletizing aid” refers to a compound that assists in the pelletilization of metal containing ore when used together with the copolymer according to the present invention. The pelletizing aid is preferably a water soluble, monomeric material. Examples of pelletizing aids are described in and suitable materials are described in EP 225 171 and EP 288 150, US4767449 and U.S. Pat. No. 4,802,914.

As used herein, the term “hydrocarbyl” or “carbon radical” refers to an aliphatic and/or aromatic, linear or branched carbon radical. Hydrocarbyl radicals such as “hydrocarbyl radical containing 2 to 50 carbon atoms”, and the like thus refer to an aliphatic and/or aromatic, linear or branched carbon radicals that contain 2 to 50 carbon atoms. For example, a hydrocarbyl radical containing 2 carbon atoms is ethyl, a hydrocarbyl radical containing 4 carbon atoms comprises n-butyl, isobutyl and/or tert-butyl.

The term “about” in the context of the present application as e.g. in “about 50% by wt.” means that the value recited immediately after the “about” means that the term also comprises minor deviations from the exact numeric value, e.g. due to weighing errors etc. In a preferred embodiment, the term “about” means a value within 15% (±15%) of the value recited immediately after the term “about,” including any numeric value within this range, the value equal to the upper limit (i.e., +15%) and the value equal to the lower limit (i.e., −15%) of this range. For example, the phrase “about 100” encompasses any numeric value that is between 85 and 115, including 85 and 115 (with the exception of “about 100%”, which always has an upper limit of 100%). In one aspect, “about” means±10%, even more preferably ±5%, even more preferably ±1% or less than ±1%. In another preferred embodiment, the term “about” as in “about 50% by wt.” means a value of 50% by wt.±1% by wt. or 50% by wt.±0.5% by wt.

### Examples 1: Preparation of Co-Polymers

100.0 g of dist. water is placed in a beaker and subsequently 149.56 g of sodium ATBS solution (50% in water), 140.82 g of acrylamide solution (50% in water) and 1.2 g of Trilon C (BASF) solution (5% in water) are added. Subsequently 0.4 g of Xiameter AFE-0400 (defoamer) and 2.82 g of vinyl oxy butyl polyethylene glycol (VOBPEG) 1100 were added and the pH was adjusted with sulfuric acid to pH 6.4. Subsequently the residual water (without the water needed for the initiators) to obtain an active content of 37% was added and the solution was cooled down to ˜3° C. and 2.4 g of V50 (Wako Chemicals) (10% solution in water) was added. After this the solution was transferred into a thermos flask and degassed by nitrogen purge for 30 min. 0.12 g of tert-Butyl hydroperoxide (tBHP) (United Initiators) (1% solution in water) is added and 1 min later 0.24 g of sodium sulfite (1% solution in water) was added in order to initiate the polymerization.

After the temperature maximum is reached (approx. 80° C.) the thermos flask was placed in a heating cabinet at 80° C. for 2 h. Afterwards the gel was granulated and dried for 2 h at 55° C. in a fluid bed drier. Subsequently the obtained polymer chips were grinded with a centrifugal mill.

### Example 2: Iron Ore Concentrate Pelletization and Pellet Analysis

A magnetite ore having around 10% moisture (9.3 to 9.7%) was blended with a powdered premix of binder formulation, using a mixer machine brand Eirich model EL1, for three minutes. The composition of the respective pellets are summarized in Table 1. The resultant intimate mixture was subjected to pelletization by using an inclined pelletizing disk of 60 cm diameter, rotating at a speed of 33 rpm. The produced pellets had a size between 9.4 to 13.4 mm. Dry pellets were produced after drying for 3 hours at 110° C. The strength of wet and dry pellets was determined using a Chatillon digital strength gauge. A total of 25 pellets were pressed in uni-axial direction and the maximum compressive strength recorded when the pellets were crushed. To determine the Drop number, wet pellets were repeatedly dropped onto a steel plate from a height of 45 cm and inspected for any visible crack. The average number of drops until a crack was detected was recorded as Drop number.

The following binder formulations were used for iron ore pelletization:

Alcotac® FE14 (BASF SE) is a commercially available organic binder for iron ore pelletization comprising a co-polymer of acrylamide and acrylate monomers. In this example Alcotac® FE14 was used as a pre mixture containing 65 wt. % of the copolymer and 35 wt. % of the sodium carbonate salt.

Formulation 1 is comprised of a copolymer based on the monomers Acrylamide (50 wt. %), Na-AMPS (48 wt. %) and vinyl oxy butyl polyethylene glycol (VOBPEG) 1100 monomer (2%) and sodium carbonate. The formulation comprised 40 wt. % of the copolymer and 60 wt. % of the sodium carbonate salt.

Formulation 2 is comprised of a copolymer based on the monomers Acrylamide (48 wt. %), Na-AMPS (48 wt. %) and vinyl oxy butyl polyethylene glycol (VOBPEG) 1100 monomer (4%) and sodium carbonate. The formulation comprised 40 wt. % of the copolymer and 60 wt. % of the sodium carbonate salt.

The binder formulation and the average results are shown in the following Table 1.

TABLE 1
composition and analysis of iron ore pellets

| | | | | | Dry | |
|---|---|---|---|---|---|---|
| | Alcotac | Formulation | Formulation | Moisture | strength | Drop |
| Test | FE14[wt. %]* | 1 [wt. %]* | 2 [wt. %]* | [%] | [N] | Number |
| A | 0.033 | | | 9.5 | 17 | 3.6 |
| (comparative) | | | | | | |
| B | | 0.033 | | 9.4 | 19 | 4.0 |
| (inventive) | | | | | | |
| C | | | 0.033 | 9.6 | 20 | 4.7 |
| (inventive) | | | | | | |

*wt. % is based on total weight of iron ore pellet.

The pellets comprising the formulations according to the present invention showed an increased dry strength and a higher drop number compared to the pellets comprising the commercially available polymer-based binder formulation.

### Example 3: Iron Ore Concentrate Pelletization Using Bentonite in Combination with Organic Binder

Following the same pelletization experimental procedure as described in the previous Example 2, binder compositions comprising bentonite together with binder formulations according to the present invention were tested.

The binder formulations 3, 4 and 5 were used for iron ore pelletization in combination with Bentonite and compared against Alcotac® FE 14 (BASF SE) used also in combination with Bentonite as a comparative case.

Alcotac® FE 14 (BASF SE) is a commercially available organic binder for iron ore pelletization comprising a co-polymer of acrylamide and acrylate monomers. In this example Alcotac® FE14 was used as a pre mixture containing 65 wt. % of the copolymer and 35 wt. % of the sodium carbonate salt.

Formulation 3 was comprised of a copolymer based on the monomers acrylamide (68 wt. %), Na-Acrylate (30 wt. %) and vinyl oxy butyl polyethylene glycol (VOBPEG) 1100 monomer (2%) and sodium carbonate. The formulation comprised 40 wt. % of the copolymer and 60 wt. % of the sodium carbonate salt.

Formulation 4 was comprised of a copolymer based on the monomers acrylamide (67 wt. %), Na-Acrylate (30 wt. %) and vinyl oxy butyl polyethylene glycol (VOBPEG) 1100 monomer (3%) and sodium carbonate. The formulation comprised 40 wt. % of the copolymer and 60 wt. % of the sodium carbonate salt.

Formulation 5 was comprised of a copolymer based on the monomers acrylamide (66 wt. %), Na-Acrylate (30 wt. %) and vinyl oxy butyl polyethylene glycol (VOBPEG) 1100 monomer (4%) and sodium carbonate. The formulation comprised 40 wt. % of the copolymer and 60 wt. % of the sodium carbonate salt.

The binder formulation and the average results are shown in Table 2.

TABLE 2
composition and analysis of iron ore pellets using bentonite
or compositions of bentonite with inventive copolymer binders

| | | Alcotac | | | | Wet | Dry | |
|---|---|---|---|---|---|---|---|---|
| | Bentonite | FE14 | Formulation | Formulation | Formulation | strength | strength | Drop |
| Test | [wt. %]* | [wt. %]* | 3 [wt. %]* | 4 [wt. %]* | 5 [wt. %]* | [N] | [N] | Number |
| D | 1.0 | 0.022 | | | | 24.5 | 55.5 | 10 |
| (comparative) | | | | | | | | |
| E | 1.0 | | 0.022 | | | 25.5 | 64.0 | 9.7 |
| (inventive) | | | | | | | | |
| F | 1.0 | | | 0.022 | | 24.0 | 59.0 | 9.9 |
| (inventive) | | | | | | | | |
| G | 1.0 | | | | 0.022 | 25.5 | 55.0 | 9.9 |
| (inventive) | | | | | | | | |

*wt. % is based on total weight of iron ore pellet.

The pellets comprising the formulations 3 and 4 according to the present invention used in combination with Bentonite provided higher dry strength values and similar drop numbers and wet strength values compared to those obtained from pellets produced using bentonite in combination with the comparative copolymer.

### Example 4: Further Experiments with Iron Ore Concentrate Pelletization Using Bentonite in Combination with Organic Binder

Iron ore pellets are prepared in 3000 g batches, in an open airplane tire and a standard procedure followed for all tests. The iron ore and binder composition is premixed in a bowl prior to agglomeration. Binder addition is calculated on a dry concentrate basis. The agglomeration device used is a 15 cm by 30 cm airplane tire to produce green balls. The produced pellets had a size between 12.7 mm and 11.2 mm. Dry pellets were produced after drying for 3 hours at 110° C. The strength of wet and dry pellets was determined using a Chatillon digital strength gauge. A total of 25 pellets were pressed in uni-axial direction and the maximum compressive strength recorded when the pellets were crushed. To determine the drop number, wet pellets were repeatedly dropped onto a steel plate from a height of 45 cm and inspected for any visible crack. The average number of drops until a crack was detected was recorded as drop number.

The binder formulations used for iron ore pelletization, resulting in the respective dry strength and drop number, are summarized in Table 3. The formulation comprised 40 wt. % of the copolymer derived from monomers of ATBS, NaAA and Monomer C, and 60 wt. % of the sodium carbonate salt.

Due to the difference in the chain length of the macromonomer, the wt % given in Table 3 for the monomer correspond to an equimolar amount of Monomer C (for formulations 7 to 9 and formulations 10 to 12, respectively).

TABLE 3
Dry strength and drop number of iron pellets using
inventive binders of different chain lengths

| | | | | | Dry | |
|---|---|---|---|---|---|---|
| | ATBS | NaAA | Monomoer | | Strength | Drop |
| Formulation | (wt %) | (wt %) | C (wt %) | Monomer C | (N) | Number |
| 7 | 47.8 | 49.8 | 2.4 | VOBPEG 3000 | 16.0 | 4.1 |
| 8 | 48.6 | 50.5 | 0.9 | VOBPEG 1100 | 15.1 | 3.2 |
| 9 | 48.8 | 50.8 | 0.4 | VOBPEG 500 | 16.9 | 3.6 |
| 10 | 46.2 | 48.0 | 5.8 | VOBPEG 3000 | 15.1 | 3.4 |
| 11 | 48.0 | 49.8 | 2.2 | VOBPEG 1100 | 14.2 | 3.9 |
| 12 | 48.6 | 50.4 | 1.0 | VOBPEG 500 | 15.6 | 3.9 |
| 13 | 46.4 | 48.24 | 5.39 | VOBPEG 5800 | 14.2 | 2.9 |

1: A process for pelletizing a metal-comprising ore, the process comprising contacting the metal-comprising ore with a copolymer comprising monomer units derived from at least one monomer C of formula (I)
H₂C═C(R¹)—R²—O(—CH₂—CH₂—O—)ₖ—CH₂—CH₂—R₃ (I),
wherein R¹ is hydrogen or methyl;
R² is absent, —C(═O)—, —CH₂—, —CH₂—CH₂— or —OR⁴, wherein R⁴ is —(CH₂)ₙ—, wherein n is a natural number from 1 to 6;
R³ is hydrogen or —OH; and
k is a number from 0 to 300.

2: The process of claim 1, wherein the copolymer comprises monomer units derived from at least one monomer C of formula (I)
H₂C═C(R¹)—R²—O(—CH₂—CH₂—O—)ₖ—CH₂—CH₂—R₃ (I),
wherein R¹ is hydrogen or methyl;
R² is absent, —CH₂—, —CH₂—CH₂— or —OR⁴, wherein R⁴ is —(CH₂)ₙ—, wherein n is a natural number from 1 to 6;
R³ is hydrogen or OH; and
k is a number from 0 to 300.

3: The process of claim 1, wherein R³ is —OH.

4: The process of claim 1, wherein k is a number from 1 to 300.

5: The process of claim 1, wherein the copolymer is used in combination with an additional binder.

6: The process of claim 5, wherein the additional binder is bentonite.

7: The process of claim 1, wherein k is a number from about 5 to about 150.

8: The process of claim 1, wherein the at least one monomer C is vinyl oxybutyl polyethylene glycol.

9: The process of claim 1, wherein the copolymer further comprises monomer units derived from at least one anionic monoethylenically unsaturated, hydrophilic monomer A.

10: The process of claim 1, wherein the copolymer further comprises monomer units derived from at least one uncharged, monoethylenically unsaturated hydrophilic monomer B.

11: The process of claim 1, wherein the copolymer comprises monomer units derived from
i. at least one anionic monoethylenically unsaturated, hydrophilic monomer A,
ii. at least one uncharged, monoethylenically unsaturated hydrophilic monomer B, and
iii. at least one monomer C of formula (I).

12: The process of claim 10, wherein the at least one monomer B is selected from the group consisting of acrylamide, methacrylamide, N-methyl methacrylamide, N-methyl acrylamide, N,N′-dimethyl acrylamide, N,N′-dimethyl methacrylamide, N-methylol acrylamide, N-methylolmethacrylamide, uncharged vinylamides and mixtures thereof.

13: The process of claim 1, wherein the copolymer comprises from about 0.1 to about 15% by wt. of the at least one monomer C of formula (I).

14: The process of claim 1, wherein the copolymer has been made by polymerization of the monomer blend in the presence of at least one branching agent.

15: The process of claim 1, wherein the copolymer does not comprise at least one anionic monoethylenically unsaturated, hydrophilic monomer A and/or at least one uncharged, monoethylenically unsaturated hydrophilic monomer B.

16: The process of claim 1, wherein the copolymer is water-soluble.

17: The process of claim 1, wherein the metal-comprising ore is selected from the group consisting of Fe-comprising ore, Cu-comprising ore, Mo-comprising ore, Ni-comprising ore, Cr-comprising ore and mixtures thereof.

18: A composition, comprising:
i. a copolymer, wherein the copolymer comprises monomer units derived from at least one monomer C of formula (I)
H₂C═C(R¹)—R²—O(—CH₂—CH₂—O—)ₖ—CH₂—CH₂—R₃ (I),
wherein R¹ is hydrogen or methyl;
R² is absent, —C(═O)—, —CH₂—, —CH₂—CH₂— or —OR⁴, wherein R⁴ is —(CH₂)ₙ—, wherein n is a natural number from 1 to 6;
R³ is hydrogen or OH; and
k is a number from 0 to 300; and
ii. a pelletisation aid and/or a water soluble treatment polymer,
wherein the pelletizing aid is a water soluble material selected from the group consisting of sodium carbonate, sodium bicarbonate, sodium silicate, sodium phosphate, sodium stearate, sodium benzoate, sodium tartrate, sodium oxalate, sodium citrate, sodium acetate, the corresponding ammonium, potassium, calcium and magnesium salts of the preceding sodium salts, urea and calcium oxide; and
wherein the water soluble treatment polymer has a molecular weight of from about 1,000 to about 20,000 and is a synthetic polymer formed by polymerization of water soluble ethylenically unsaturated anionic monomer or water soluble ethylenically unsaturated monomer blend comprising at least 50% by weight of an anionic monomer.

19: The composition of claim 18, further comprising an absorbent aluminium phyllosilicate.

20: The composition of claim 18, wherein the copolymer of i. comprises monomer units derived from at least one monomer C of formula (I)
H₂C═C(R¹)—R²—O(—CH₂—CH₂—O—)ₖ—CH₂—CH₂—R₃ (I),
wherein R¹ is hydrogen or methyl;
R² is absent, —CH₂—, —CH₂—CH₂— or —OR⁴, wherein R⁴ is —(CH₂)ₙ—, wherein n is a natural number from 1 to 6;
R³ is hydrogen or OH; and
k is a number from 0 to 300.

21: The composition of claim 18, wherein R³ is —OH and/or k is a number from 1 to 300.

22: The composition of claim 18, wherein k is a number from about 5 to about 150.

23: The composition of claim 18, wherein the at least one monomer C is vinyl oxybutyl polyethylene glycol.

24: The composition of claim 18, wherein the copolymer of i. further comprises monomer units derived from at least one anionic monoethylenically unsaturated, hydrophilic monomer A.

25: The composition of claim 18, wherein the copolymer of i. further comprises monomer units derived from at least one uncharged, monoethylenically unsaturated hydrophilic monomer B.

26: The composition of claim 18, wherein the copolymer of i. comprises monomer units derived from
i. at least one anionic monoethylenically unsaturated, hydrophilic monomer A,
ii. at least one uncharged, monoethylenically unsaturated hydrophilic monomer B, and
iii. at least one monomer C of formula (I).

27: The composition of claim 25, wherein the at least one monomer B is selected from the group consisting of acrylamide, methacrylamide, N-methyl methacrylamide, N-methyl acrylamide, N,N′-dimethyl acrylamide, N,N′-dimethyl methacrylamide, N-methylol acrylamide, N-methylolmethacrylamide, uncharged vinylamides and mixtures thereof.

28: The composition of claim 18, wherein the copolymer of i. comprises from about 0.1 to about 15% by wt. of the at least one monomer C of formula (I).

29: The composition of claim 18, wherein the copolymer of i. has been made by polymerization of the monomer blend in the presence of at least one branching agent.

30: The composition of claim 18, wherein the copolymer of i. does not comprise at least one anionic monoethylenically unsaturated, hydrophilic monomer A and/or at least one uncharged, monoethylenically unsaturated hydrophilic monomer B.

31: The composition of claim 18, wherein the copolymer of i. is water-soluble.

32: The composition of claim 18, wherein the metal-comprising ore is selected from the group consisting of Fe-comprising ore, Cu-comprising ore, Mo-comprising ore, Ni-comprising ore, Cr-comprising ore and mixtures thereof.
